(19) United States
(12) Patent Application Publication
(10) Pub. No.: US 2006/0093241 A1
(43) Pub. Date: May 4, 2006

(54) Document management apparatus and document management method, and storage medium storing program

(75) Inventors: Osamu Nakamura, Yokohama-shi (JP); Mitsuru Aonuma, Yokohama-shi (JP); Katsuji Tokie, Yokohama-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/143,452

(22) Filed: Jun. 3, 2005

(30) Foreign Application Priority Data
Nov. 4, 2004 (JP) 2004-320390

(51) Int. Cl. G06K 9/54

(52) U.S. Cl. 382/306

(57) ABSTRACT

A document management apparatus includes a hash processor and a microfilm writer. The hash processor generates a hash value based on digital document data stored in a database. The microfilm writer records image data converted from the digital document data on a microfilm, and records a document ID as identification information of the converted document data recorded on the microfilm, and the hash value, on the microfilm.

### BACKGROUND OF THE INVENTION

1. Field of the Invention

The present invention relates to a document management apparatus and a document management method and a computer-readable storage medium storing a computer program. More particularly, the present invention relates to a document management apparatus having a construction capable of checking occurrence/nonoccurrence of change by tampering or the like of data stored in a database, and a document management method and a computer-readable storage medium storing a computer program.

2. Description of the Related Art

In a construction to store and manage various document data including text data, image data and program data, when document data is stored in a database connected to e.g. a network, there is a probability of data tampering or the like by external unauthorized access. Recent document management systems employ various arrangements to prove the reliability of managed data, more particularly, the occurrence/nonoccurrence of tampering of management subject document data. For example, the technology using a digital signature is well known. However, when key update is performed, update of the digital signature is required. That is, it is necessary to update digital signature data by using an updated key. This processing causes heavy load on the document management apparatus which manages a huge amount of document data over a long period of time.

To address this problem, a method of storing analog data converted from digital data on a microfilm is known. For example, Japanese Published Unexamined Patent Application No. 2002-202903 discloses converting digital information to analog information and storing on a microfilm as a method for long-term storage of document and figures. Further, Japanese Published Unexamined Patent Application No. 2003-263440 discloses an apparatus which holds data by using both microfilm and an electronic medium in compensation for a demerit of digital data with a merit of a microfilm.

These related arts employ the following techniques.

(1) Indexing a document upon conversion from digital data to analog data for storage. The indexing mutually links a digital folder to an analog folder (Japanese Published Unexamined Patent Application No. 2002-202903).

(2) Recording index information linking data on a microfilm with an electronic medium by image, so as to make full use of the characteristics of the microfilm and the electronic medium. When a document on the electronic medium corresponding to data on the microfilm is referred to, the document is specified from the index information, thereby the document can be obtained (Japanese Published Unexamined Patent Application No. 2003-263440).

However, in the construction described in the Japanese Published Unexamined Patent Application No. 2002-202903, index data related to image data is link information and/or image attribute information, or further, unique data verifier to specify an image itself. Accordingly, the identity of the original is maintained at the time of recording, however, change (or tampering) of data on the electronic medium, if made, since the recording on the microfilm, cannot be verified. Accordingly, complete correspondence with document data cannot be ensured, and it cannot be ensured whether the both data have the same content.

The construction described in the Japanese Published Unexamined Patent Application No. 2003-263440 is a hybrid system utilizing the merits of both microfilm and electronic medium. However, when original electronic data is application data by a word processor or the like, generally the data is converted to digital image data for printing, then converted to analog data. Accordingly, in the related art, although the digital image data for printing can be linked with an image on the microfilm, nonoccurrence of change (or tampering) of original application data cannot be ensured.

### SUMMARY OF THE INVENTION

The present invention has been made in view of the above problems and provides a document management apparatus having a construction for generating a microfilm corresponding to digital data for data storage, capable of ensuring the correspondence between digital data and data recorded on microfilm and checking of occurrence/nonoccurrence of digital data tampering based on the data recorded on the microfilm, and a document management method and a computer-readable storage medium storing a computer program.

Especially, the present invention provides a document management apparatus which records converted document data corresponding to digital data on a microfilm and records a hash value based on the document data by using a bar code, and which is capable of checking occurrence/nonoccurrence of digital data tampering based on the hash value, and a document management method and a computer-readable storage medium storing a computer program.

According to an aspect of the invention, there is provided a document management apparatus including: a hash processor that generates a hash value based on digital document data stored in a database; and a microfilm writer that performs processing to record converted document data, converted to image data based on the digital document data, on a microfilm, and record a document ID, as identification information of the converted document data recorded on the microfilm, and the hash value, on the microfilm.

Other features and advantages of the present invention will be apparent from the following description taken in conjunction with the accompanying drawings. Note that in the present specification, the system means a logical set of plural apparatuses, and the respective constituent apparatuses are not necessarily arranged in one casing.

### BRIEF DESCRIPTION OF THE DRAWINGS

These and other features, aspects, and advantages of the present invention will become better understood with reference to the following description and accompanying drawings, which should not be read to limit the invention in any way, in which:

FIG. 1 is a block diagram showing the construction of a document management apparatus according to the present invention;

FIG. 2 is an explanatory diagram showing the details of the processing procedure of microfilm generation processing performed by the document management apparatus according to the present invention;

FIGS. 3A and 3B are examples of data recording structure in a microfilm generated by the document management apparatus according to the present invention;

FIG. 4 is a flowchart showing the details of the processing procedure of the microfilm generation processing performed by the document management apparatus according to the present invention;

FIG. 5 is a flowchart showing data verification processing based on recorded information on the microfilm generated by the document management apparatus according to the present invention; and

FIG. 6 is a block diagram showing the hardware construction of the document management apparatus to perform the microfilm generation processing and the data verification processing.

### DETAILED DESCRIPTION OF THE INVENTION

Hereinbelow, the details of a document management apparatus, a document management method, and a computer program of the present invention will now be in accordance with the accompanying drawings.

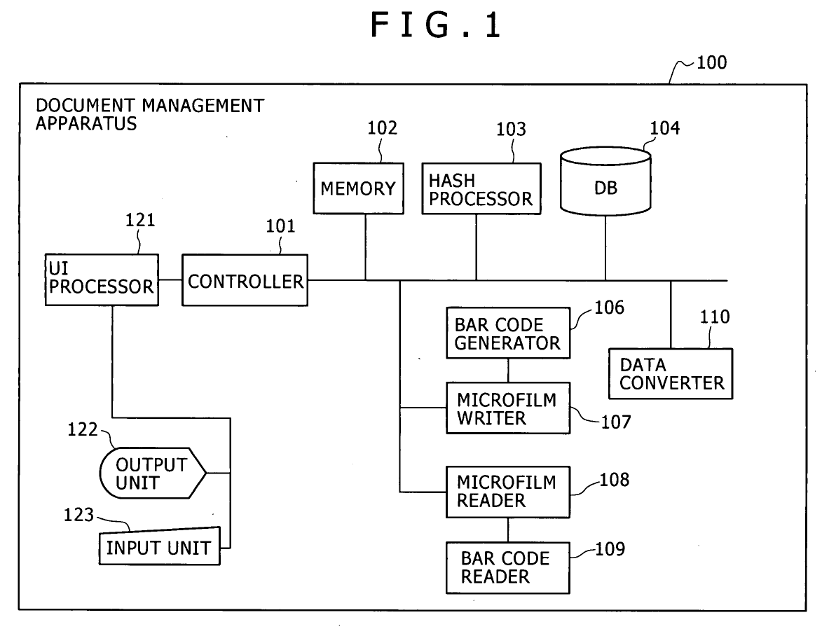

FIG. 1 shows the construction of the document management apparatus of the present invention. A document management apparatus 100 manages a large amount of document data stored in a database (DB) 104. Regarding the document data, proving of the occurrence/nonoccurrence of data tampering or the like is required. Further, the document management apparatus generates a microfilm corresponding to the data stored in the database (DB) 104.

That is, the document management apparatus of the present invention is a hybrid system which performs processing to store digital data on a recording medium, e.g., a hard disk, a CD or a DVD in the database (DB) 104, and to generate a microfilm as analog data corresponding to the digital data stored in the database (DB) 104, thus manages document data as digital and analog data.

As shown in FIG. 1, the document management apparatus 100 has a controller 101, a memory 102, a hash processor 103, the database (DB) 104, a bar code generator 106, a microfilm writer 107, a microfilm reader 108, a bar code reader 109, a data converter 110, a user interface (UI) processor 121, an output unit 122 and an input unit 123.

The controller 101 performs data processing and data communication control in the document management apparatus 100. The controller 101 reads a computer program stored in the memory 102, and performs data processing in accordance with the program. The memory 102 is a memory having a hard disk, a ROM, a RAM and the like used as a computer program storage area, as a work area for other programs, and as a parameter storage unit.

The hash processor 103 performs hash value generation processing based on management subject document data. The hash value generation processing is performed as processing using a predetermined hash function such as SHA-1 or MD5. The database (DB) 104 holds management subject data. As described above, regarding the management subject data, proving of occurrence/nonoccurrence of data tampering or the like is required.

The microfilm writer 107 and the microfilm reader 108 perform data writing upon generation of a microfilm as analog data corresponding to management subject document data and data reading from the generated microfilm. The bar code generator 106 performs processing to convert attribute data corresponding to document data recorded by the microfilm writer 107, i.e., a hash value and a document ID corresponding to the document data, and the like, into bar codes. The bar code reader 109 performs reading processing to read the bar code information recorded, with the document data as the subject of management, on the microfilm.

The data converter 110 performs processing to convert digital document data stored in the database 104 to microfilm-recordable data format such as TIFF data format.

Note that in recording of management subject document data by the microfilm writer 107, the document processing apparatus of the present invention performs processing to generate a hash value based on the document data, as proof data for proving occurrence/nonoccurrence of data change by data tampering or the like, by the hash processor 103, then convert these data pieces to bar codes, and record the bar codes, with the document data, on the microfilm. The details of the processing will be described later.

The user interface (UI) processor 121 performs input/output control on the output unit 122 and the input unit 123. The output unit 122 has a display such as a CRT or LCD, produces various information displays. The input unit 123, having a keyboard, a mouse and the like, is utilized for a user's information input.

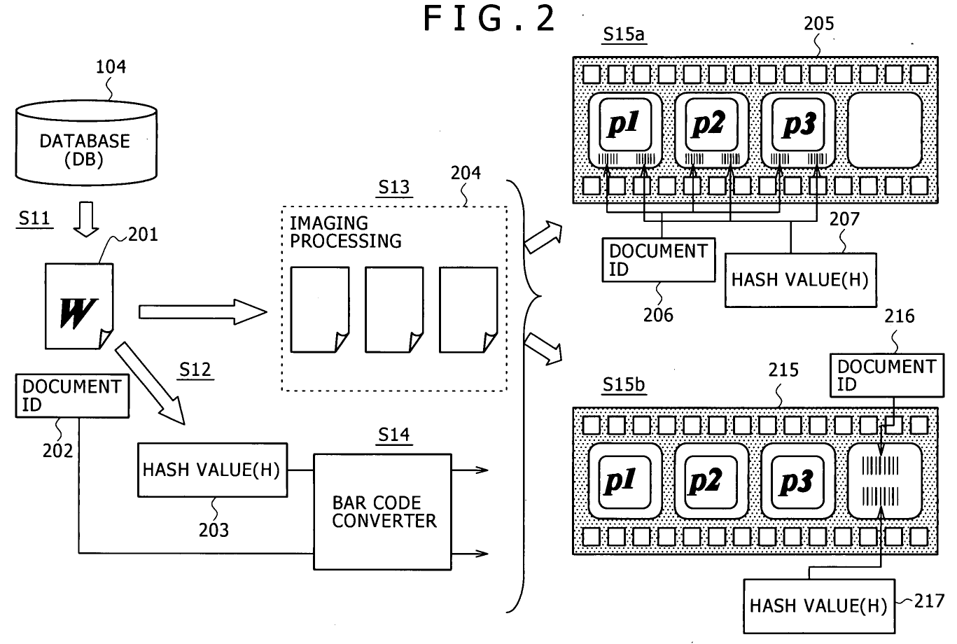

Microfilm generation processing performed in the document management apparatus 100, i.e., processing to generate converted document data as image data to be recorded on a microfilm based on digital document data stored in the database (DB) 104, will be described with reference to FIG. 2 and the subsequent figures.

FIG. 2 is an explanatory view showing the outline of the microfilm generation processing according to the present invention. First, at step S11, processing subject document data is obtained from the database 104. The obtained data includes digital document data 201 and a document ID 202 as identification information of the digital document data 201.

At step S12, a hash vale (H) 203 is generated based on the digital document data 201. The hash value (H) is generated based on digital document data to be recorded on the microfilm. That is, a predetermined hash function such as SHA-1 or MD5 is applied to constitute bit values of the digital document data as an input value, and the hash value (H) is calculated. Assuming that the hash function is (h) and the digital document data is (Document), the hash value (H) is calculated as follows.
H=h(Document)

At step S13, the digital document data is converted to a form appropriate for imaging for page p1, p2, p3 . . . of the digital document data, i.e., microfilm-recordable image data such as TIFF format data, thereby converted document data 204 is generated.

At step S14, the document ID 202 and the hash value (H) 203 are converted to bar codes. At step S15, processing to record the converted document data 204, and the document ID 202 and the hash value (H) 203 converted to bar codes, on the microfilm, is performed. FIG. 2 shows different data recording examples at steps S15a and S15b.

Any one of steps S15a and S15b is selected and data recording on the microfilm is performed. In the recording on a microfilm 205 at step S15a, a document ID 206, and a hash value (H) 207, converted to bar codes are recorded by each page of image data, i.e., recording frame. On the other hand, in the recording on a microfilm 215 at step S15b, the document ID and hash value are not recorded by page of image data, but a document ID 216 and a hash value (H) 217 converted to bar codes are recorded in a frame independent of a frame where page data of processing subject document is recorded. In the example of processing at step S15b, one document ID and one hash value corresponding to the document are written only once.

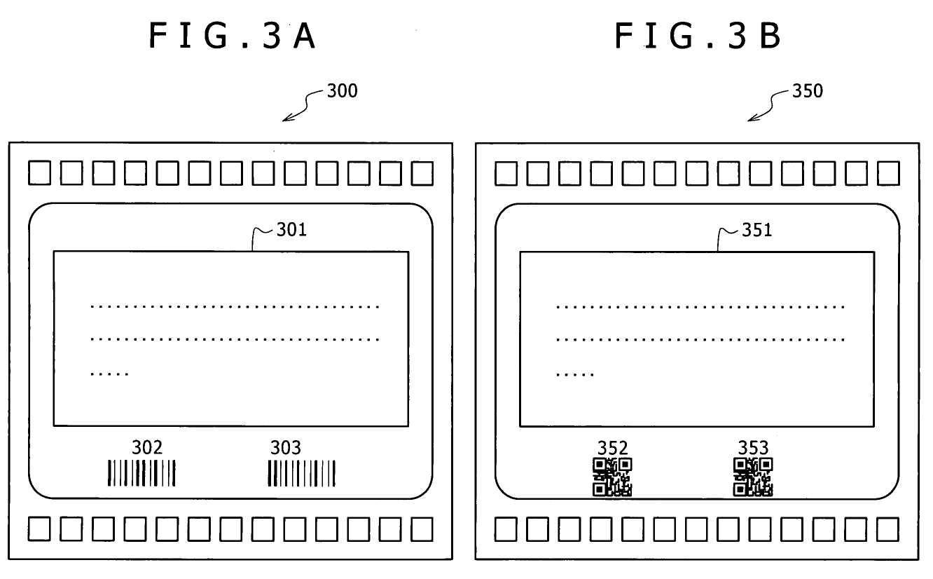

FIGS. 3A and 3B are examples of data recording structure in a microfilm where a document ID and a hash value are written by page (frame). FIG. 3A shows an example of recording using one-dimensional bar codes, and FIG. 3B shows an example of recoding using two-dimensional bar codes. In a microfilm 300 shown in FIG. 3A, a document ID 302 is recorded as a one-dimensional bar code in a lower left position of document data 301, and a hash value 303 is recorded as a one-dimensional bar code in a lower right position of the document data 301.

Further, in a microfilm 350 shown in FIG. 3B, a document ID 352 is recorded as a two-dimensional bar code in a lower left position of document data 351, and a hash value 353 is recorded as a two-dimensional bar code in a lower right position of the document data 351. In this manner, one-dimensional bar codes and two-dimensional bar codes are used as bar codes. FIGS. 3A and 3B show examples of data recording structure in a microfilm where a document ID and a hash value are written by page (frame), however, in a case where a document ID and a hash value are written in a frame independent of a frame where each page data piece is recorded, various forms of bar codes such as one-dimensional bar code and two-dimensional bar code may be used.

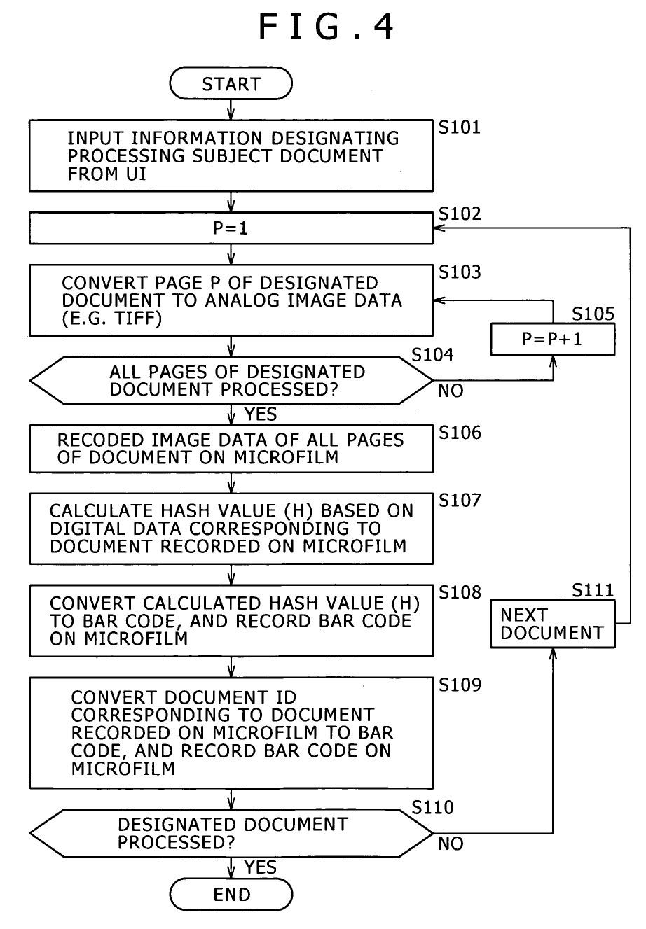

Next, the details of the procedure of the microfilm generation processing performed by the document management apparatus 100 will be described with reference to the flowchart of FIG. 4. The processing at respective steps will be described.

At step S101, information designating a processing subject document is inputted via the input unit 123 of the document management apparatus 100. The processing on the document is to generate a microfilm where converted document data as image data corresponding to the digital document data, as analog data corresponding to the digital data stored in the database 104, is recorded, and upon generation of microfilm, generate proof data for proving occurrence/nonoccurrence of tampering of processing subject document data, and record the proof data on the microfilm.

At step S102, initialization setting is performed to set page designation information [p] of the processing subject document as p=1, to set the initial page as processed page. At step S103, processing to convert the processed page [p] of the processing subject document as digital data stored in the database 104, to image data as analog data (e.g. TIFF) is performed, thereby converted document data is generated. This processing is performed by the data converter 110, to convert the digital data stored in the database 104 to microfilm-recordable format data. Note that the converted data format is not limited to TIFF but any other data format may be employed as long as it is a microfilm-recordable data format.

At step S104, it is determined whether or not the generation of analog image data for all the pages of the processing subject document has been completed. If unprocessed page(s) exits, the processed page [p] is updated at step S105, and the process proceeds to the data conversion processing at step S103.

When the data conversion for all the pages of the processing subject document has been completed, the process proceeds to step S106, at which image data (e.g. TIFF data) of the respective pages of data-conversion processed document are recorded on a microfilm. The data recording is performed by the microfilm writer 107.

Next, at step S107, a hash value (H) based on the document data recorded on the microfilm is calculated. This processing is performed by the hash processor 103 of the document management apparatus 100 shown in FIG. 3. The hash value (H) is generated based on digital data corresponding to the document data recorded on the microfilm. That is, a predetermined hash function such as SHA-1 or MD5 is applied to constitute bit values of the digital document data as input values, and the hash value (H) is calculated. Assuming that the hash function is (h) and the digital document data is (Document), the hash value (H) is calculated as follows.
H=h(Document)

Next, at step S108, the calculated hash value (H) is converted to a bar code, and is recorded on the microfilm where the document data is recorded. The bar code conversion processing is performed by the bar code generator 106. The recording processing of the generated bar code is performed by the microfilm writer 107.

Note that as described above with reference to FIG. 2 and FIGS. 3A and 3B, as the recording of bar codes, recording by frame where page data is recorded, or recording in a frame independent of a frame where page data of processed document is recorded, is selected. Further, as bar codes, various forms of bar codes such as one-dimensional bar codes and two-dimensional bar codes may be used.

Next, at step S109, a document ID corresponding to the microfilm-recorded document is converted to a bar code and recorded on the microfilm. The document ID is document identification data applied in the database 104 holding the digital document data. This document identification data is converted by the bar code generator 106 to a bar code, and the converted data is recorded by the microfilm writer 107.

At step S110, it is determined whether or not the recording processing for the designated processing subject document has been completed. If an unprocessed document exists, document update is performed at step S111, and the processing at step S102 and the subsequent steps is performed for the next processing subject document.

If it is determined at step S110 that the recording processing for the designated processing subject document has been completed, the microfilm generation processing is completed.

In this manner, in the document management apparatus according to the present invention, document data recorded in a database is recorded, with a document ID, on a microfilm, and a hash value based on the document data is recorded on the microfilm where the document data is recorded. In this construction, it can be determined whether or not data change by data tampering or the like has occurred regarding a managed document.

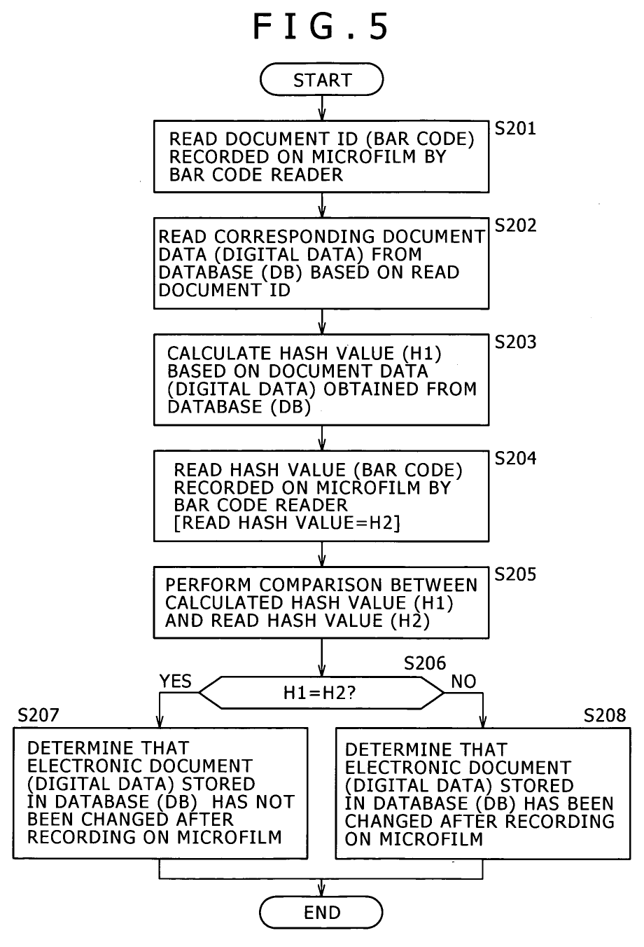

Next, a data verification sequence based on information recorded on a microfilm will be described with reference to FIG. 5.

First, at step S201, the document ID recorded as a bar code on the microfilm is read by data reading processing using the microfilm reader 108 and the bar code reader 109. At step S15a in FIG. 2, the document ID 206 is read, and at step S15b in FIG. 2, the document ID 216 is read. At step S202, the corresponding digital document data stored in the database (DB) 104 is obtained with the document ID obtained from the bar code as an index. The corresponding digital document data means digital document data corresponding to the document recorded as analog data on the microfilm.

Next, at step S203, a hash value (H1) based on the digital document data obtained from the database (DB) 104 is calculated. The hash value (H1) is calculated by applying a predetermined hash function such as SHA-1 or MD5 to constituent bit values of the digital document data as input values. Assuming that the hash function is (h) and the digital document data is (Document), the hash value (H1) is calculated as follows.
H1=h(Document)

Next, at step S204, a hash value (H2) recorded as a bar code on the microfilm is read by data reading processing using the microfilm reader 108 and the bar code reader 109. At step S15a in FIG. 2, the hash value 207 is read, and at step S15b in FIG. 2, the hash value 217 is read.

At step S205, comparison processing is performed between the hash value (H1) calculated based on the data stored in the database and the hash value (H2) recorded as a bar code on the microfilm. If the determination of correspondence is made at step S206, i.e.,

if H1=H2 holds (step S206=Yes)

the process proceeds to step S207, at which it is determined that the electronic document (digital data) stored in the database (DB) 104 has not been changed after the time of microfilm generation.

On the other hand, if the determination of correspondence is not made at step S206, i.e.,

if H1≠H2 holds (step S206=No),

the process proceeds to step S208, at which it is determined that the electronic document (digital data) stored in the database (DB) 104 has been changed after the time of microfilm generation.

In this manner, it can be checked whether or not digital data stored in the database has been changed after the time of microfilm generation processing, by comparison between the hash value recorded as a bar code on the microfilm and the hash value based on the document data.

The present invention provides a construction which can check the occurrence/nonoccurrence of digital data tampering after the time of microfilm generation, merely by storing the microfilm. This implements a document management system having an efficient and low-cost data proving function.

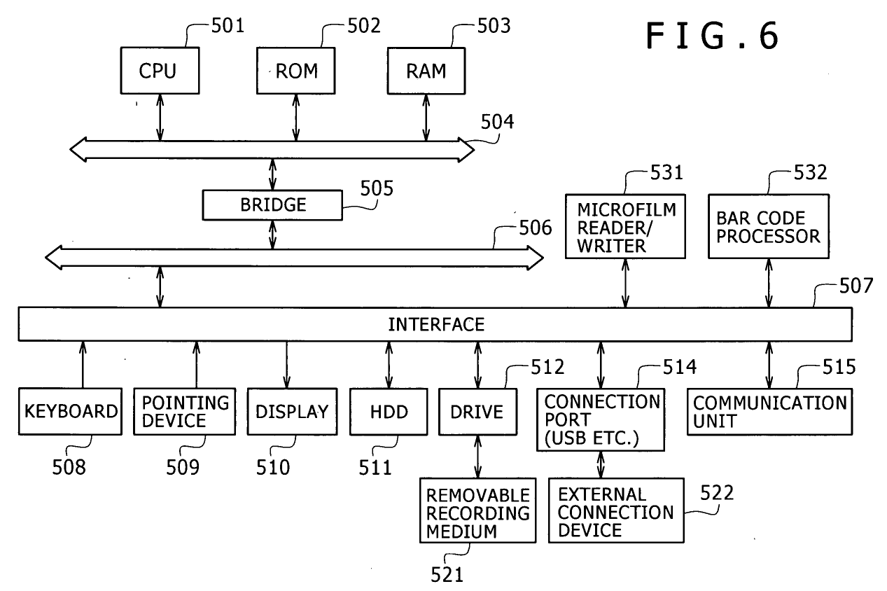

Finally, the hardware construction of the document management apparatus 100 to perform the above-described processing will be described with reference to FIG. 6.

A CPU (Central Processing Unit) 501 is a controller which performs processing according to the OS (Operating System) and the various computer programs describing the respective processing execution sequences such as the microfilm generation processing and the data verification processing described in the above embodiment. Note that the computation processing accompanying the hash value generation using a predetermined hash function is also performed in accordance with a computation processing program under the control of the CPU 501.

A ROM (Read Only Memory) 502 holds the programs and operation parameters used by the CPU 501. A RAM (Random Access Memory) 503 holds the programs used upon execution by the CPU 501 and parameters which arbitrarily change upon execution of the programs. These memories are mutually connected via a host bus 504 which is a CPU bus or the like.

The host bus 504 is connected to an external bus 506 such as a PCI (Peripheral Component Interconnect/Interface) bus via a bridge 505.

A keyboard 508 and a pointing device 509 are input devices operated by a user. A display 510, having a liquid crystal display or a CRT (Cathode Ray Tube), displays various information in the form of text or image.

An HDD (Hard Disk Drive) 511, including a hard disk, drives the hard disk, and records or reproduces the programs executed by the CPU 501 and information. The hard disk serves as the database (DB) 104 shown in FIG. 1. Further, various computer programs such as various data processing programs are stored in the hard disk.

A drive 512 reads data or a program recorded on a removable recording medium 521 such as a magnetic disc, an optical disc, a magneto-optical disc or a semiconductor memory, attached to the apparatus, and supplies the read data or program to the RAM 503 connected via an interface 507, the external bus 506, the bridge 505 and the host bus 504. The removable recording medium 521 also serves as the database (DB) 104 shown in FIG. 1.

A connection port 514 which is a port for connection with an external connection device 522, has a connection portion such as a USB port or an IEEE 1394 port. The connection port 514 is connected to the CPU 501 and the like via the interface 507, the external bus 506, the bridge 505, the host bus 504 and the like. A communication unit 515, connected to a network, performs communication processing for data communication with the outside.

The microfilm reader/writer 531 performs data writing processing and data reading processing on the microfilm. A bar code processor 532 performs barcode data generation and bar code reading processing.

Note that the hardware construction of the document management apparatus shown in FIG. 6 is an example of the apparatus applied to a PC. The document management apparatus of the present invention is not limited to the construction shown in FIG. 6, but any construction may be employed as long as the processing as described in the above embodiment can be executed.

Note that the series of processing described in the specification can be performed by a hardware construction or a software construction, or by a combined hardware and software construction. In the case of execution by the software construction, a program where the processing sequence is recorded is installed into a computer memory incorporated in specialized hardware and is executed there, otherwise, the program is installed into a general-purpose computer capable of executing various processing and is executed there.

For example, the program may be previously recorded in a hard disk or a ROM (Read Only Memory) as a recording medium. Otherwise, the program may be temporarily or permanently stored (recorded) on a removable recording medium such as a flexible disc, a CD-ROM (Compact Disc Read Only Memory), an MO (Magneto optical) disc, a DVD (Digital Versatile Disc), a magnetic disc, or a semiconductor memory. Such a removable recording medium can be provided as so-called package software.

Note that the program is installed from the removable recording medium as described above to a computer, and further, the program may be transmitted to the computer by wireless communication from a download site, or transferred by cable communication to the computer via a network such as a LAN (Local Area Network) or the Internet. The computer receives the program transferred as described above, and installs the program in its internal recording medium such as a hard disk.

Note that the various processing described in the specification is time sequentially performed in accordance with the description, further, the processing may be performed in parallel or independently in accordance with the processing performance of the apparatus or necessity. Further, the system in the specification means a logical set of plural apparatuses, but the respective constituent apparatuses are not necessarily arranged in one casing.

As described above, according to the construction of the present invention, converted document data, corresponding to digital data stored in a database for managing document data as digital data, is recorded on a microfilm, and a document ID of the document data recorded on the microfilm and a hash value based on the document data are recorded by using, e.g., bar codes. In this arrangement, it can be checked based on the hash value whether or not the digital data stored in the database has been changed after the recording processing of the document data on the microfilm. That is, if a hash value (H1) newly calculated based on the document data stored as digital data in the database corresponds with the hash value (H2) read from the microfilm, it can be determined that the digital data has not been changed after the time of recording on the microfilm. Thus the arrangement can be utilized as a document data management system which performs necessary verification of data tampering and the like.

As described above, according to an aspect of the invention, there is provided a document management apparatus which has a hash processor that generates a hash value based on digital document data stored in a database, a microfilm writer that performs processing to record converted document data, converted to image data based on the digital document data, on a microfilm, and record a document ID, as identification information of the converted document data recorded on the microfilm, and the hash value, on the microfilm.

Further, according to an embodiment of the document management apparatus of the present invention, the document management apparatus may further include a bar code generator that converts the document ID and the hash value into bar codes, and the microfilm writer may record the document ID and the hash value, as bar code information generated by the bar code generator, on the microfilm.

Further, according to another embodiment of the document management apparatus of the present invention, the document management apparatus may further include: a microfilm reader that reads information from the microfilm where the document ID and the hash value, with the converted document data, are recorded; and a data processor that performs comparison processing between a hash value calculated based on the digital document data stored in the database and the hash value read from the microfilm, and occurrence/nonoccurrence of data change may be checked based on the result of the comparison.

Further, according to another embodiment of the document management apparatus of the present invention, in the recording processing of the document ID and the hash value on the microfilm, the microfilm writer may perform processing to record the document ID and the hash value in the same recording frame of the converted document data, or perform processing to record the document ID and the hash value in a recording frame different from that of the converted document data.

Further, according to another aspect of the invention, there is provided a storage medium readable by a computer, the storage medium storing a program of instructions executable by the computer to perform a function for document management processing on the computer, the function including: generating a hash value based on digital document data stored in a database; and performing processing to record converted document data, converted to image data based on the digital document data, on a microfilm, and record a document ID, as identification information of the converted document data recorded on the microfilm, and the hash value, on the microfilm.

Further, according to an embodiment of the storage medium storing a program of the present invention, the function may further include: converting the document ID and the hash value into bar codes, and processing is performed to record the document ID and the hash value, as generated bar code information, on the microfilm.

Further, according to another embodiment of the storage medium storing a program of the present invention, the function may further include: reading information from the microfilm where the document ID and the hash value, with the converted document data, are recorded; and performing comparison processing between a hash value calculated based on the digital document data stored in the database and the hash value read from the microfilm.

Further, according to embodiment aspect of the storage medium storing a program of the present invention, in the recording processing of the document ID and the hash value on the microfilm, processing may be performed to record the document ID and the hash value in the same recording frame of the converted document data, or processing may be performed to record the document ID and the hash value in a recording frame different from that of the converted document data.

Further, according to another aspect of the invention, there is provided a document management method including: in a hash processor, generating a hash value based on digital document data stored in a database; and performing processing to record converted document data, converted to image data based on the digital document data, on a microfilm, and record a document ID, as identification information of the converted document data recorded on the microfilm, and the hash value, on the microfilm.

Note that the computer program of the present invention can be provided from a computer-readable storage medium, a communication medium, a recording medium such as a CD, an FD or an MO, or a communication medium such as a network, to a computer system which can execute various program codes. The program is provided in a computer-readable format, thereby processing corresponding to the program is implemented on the computer system.

According to the construction of the present invention, converted document data, corresponding to digital data stored in a database for managing document data as digital data, is recorded on a microfilm, and a document ID of the document recorded on the microfilm and a hash value based on the document data, are recorded by using, e.g., bar codes. In this arrangement, it can be checked based on the hash value whether or not the digital data stored in the database has been changed after the recording of the document data on the microfilm. That is, if a hash value (H1) newly calculated based on the document data stored as digital data in the database corresponds with the hash value (H2) read from the microfilm, it can be checked that the digital data stored in the database has not been changed after the recording of the document data on the microfilm.

As described above, the present invention has been described with reference to the particular embodiments. However, it is obvious for the persons skilled in the art that modifications and substitutions of the embodiments can be made without departing from the subject matter of the present invention. That is, as the present invention is disclosed in the form of exemplification, but is not directed to restrict interpretation. Therefore, to appraise the public of the scope of the present invention, the following claims are made.

The entire disclosure of Japanese Patent Application No. 2004-320390 filed on Nov. 4, 2004 including specification, claims, drawings and abstract is incorporated herein by reference in its entirety.

What is claimed is:

1. A document management apparatus comprising:
a hash processor that generates a hash value based on digital document data stored in a database; and
a microfilm writer that records image data converted from the digital document data on a microfilm, and records a document ID as identification information of the converted digital document data and the hash value, on the microfilm.

2. The document management apparatus according to claim 1, further comprising:
a bar code generator that generates bar code information by converting the document ID and the hash value into bar codes,
wherein the microfilm writer records the bar code information on the microfilm.

3. The document management apparatus according to claim 1, further comprising:
a microfilm reader that reads information from the microfilm where the document ID and the hash value, with the converted document data, are recorded; and
a data processor that performs comparison processing between a hash value calculated based on the digital document data stored in the database and the hash value read from the microfilm,
wherein occurrence/nonoccurrence of data change is checked based on a result of the comparison.

4. The document management apparatus according to claim 1, wherein in the recording processing of the document ID and the hash value on the microfilm, the microfilm writer performs processing to record the document ID and the hash value in the same recording frame of the converted document data, or performs processing to record the document ID and the hash value in a recording frame different from that of the converted document data.

5. A storage medium readable by a computer, the storage medium storing a program of instructions executable by the computer to perform a function for document management processing on the computer, the function comprising:
generating a hash value based on digital document data stored in a database; and
performing processing to record image data converted from the digital document data on a microfilm, and record a document ID as identification information of the converted document data and the hash value, on the microfilm.

6. The storage medium storing a program according to claim 5, the function further comprising:
generating bar code information by converting the document ID and the hash value into bar codes,
performing processing to record the document ID and the hash value as generated bar code information on the microfilm.

7. The storage medium storing a program according to claim 5, the function further comprising:
reading information from the microfilm where the document ID and the hash value with the converted document data are recorded; and
performing comparison processing between a hash value calculated based on the digital document data stored in the database and the hash value read from the microfilm.

8. The storage medium storing a program according to claim 5, wherein in the performing processing to record the document ID and the hash value on the microfilm, processing is performed to record the document ID and the hash value in the same recording frame of the converted document data, or processing is performed to record the document ID and the hash value in a recording frame different from that of the converted document data.

9. A document management method comprising:
generating a hash value based on digital document data stored in a database;
performing processing to record image data converted from the digital document data on a microfilm; and
performing processing to record a document ID, as identification information of the converted document data and the hash value, on the microfilm.

10. A document management apparatus comprising:
a hash processor that generates a hash value based on data; and
a microfilm writer that records the data on a microfilm, and records a data ID as identification information of the data, and the hash value, on the microfilm.
